(19) United States
(12) Patent Application Publication
(10) Pub. No.: US 2008/0151123 A1
(43) Pub. Date: Jun. 26, 2008

(54) BROADCASTING RECEIVER

(75) Inventors: Sung Jun Na, Yonginsi (KR); Chung Ku Yie, Bupyeong-gu (KR); Eun Kyung Kwak, Seoul (KR)

Correspondence Address: KED & ASSOCIATES, LLP, P.O. Box 221200, Chantilly, VA, 20153-1200, US

(73) Assignee: HUMAX Co., Ltd.

(21) Appl. No.: 11/962,457

(22) Filed: Dec. 21, 2007

(30) Foreign Application Priority Data
Dec. 21, 2006 (KR) 10-2006-0131585
Dec. 26, 2006 (KR) 10-2006-0133367
Dec. 28, 2006 (KR) 10-2006-0136054

(51) Int. Cl. H04N 5/46

(52) U.S. Cl. 348/729; 348/E05.114

(57) ABSTRACT

This document relates to a broadcasting receiver that receives TV and radio broadcasting. In an embodiment of this document, the broadcasting receiver comprises one or more channel select units for receiving TV and radio services, a display unit, a plurality of audio output units, and a controller. If a radio service is selected while a TV service is played, the controller determines whether the radio service is within the same transponder as that of the TV service, and if it is determined that the radio service is within the same transponder, controls the channel select units, the display unit, and the audio output unit to receive the TV service and the radio service at the same time and output video of the TV service and audio of the radio service.

This nonprovisional application claims priority under 35 U.S.C. §119(a) on Patent Applications No. 10-2006-131585 filed on 2006-Dec.-21, No. 10-2006-133367 filed on 2006-Dec.-26, and No. 10-2006-136054 filed on 2006-Dec.-28 in Republic of Korea the entire contents of which are hereby incorporated by reference.

### BACKGROUND

1. Field

This document relates to a broadcasting receiver which can receive TV services and radio services provided through digital broadcasting at the same time.

2. Related Art

Various kinds of digital TV (D-TV) that are able to receive digital broadcasting and output video of a high picture quality and audio of a high sound quality have been commercialized and widely popularized. In recent years, slim digital TV that uses a display panel, such as liquid crystal, is gaining popularity.

In digital broadcasting, several services are multiplexed within one transponder (TP) and then transmitted. TV services (TV_Service) and radio services (Radio_Service) can be multiplexed within the transponder.

Digital TV is configured to select one transponder through a tuner built therein and to also select one of several services multiplexed within the selected transponder, so that it receives service of a channel desired by a user.

If radio service within a tuned transponder is selected and audio with a high volume and a middle/low volume is output in slim digital TV, for example, LCD TV, vibration is generated in a LCD, etc. and, therefore, there is a problem that durability of several devices is lowered.

Further, if the LCD keeps displayed when only radio service is provided, there are problems that not only the power is unnecessarily consumed, but also the display performance of the LCD may be degraded due to a signalless input for a long time.

In addition, there is no efficient solution for allowing a user to listen to audio of radio broadcasting independently while viewing video of TV broadcasting. Accordingly, there is an urgent need for the solution.

### SUMMARY

An aspect of this document is to efficiently perform output control and display control of video and audio in a TV and radio broadcasting receiver.

In an aspect, a broadcasting receiver may comprise one or more channel select units for receiving TV and radio services, a display unit, a plurality of audio output units, and a controller. If a radio service is selected while a TV service is played, the controller determines whether the radio service is within the same transponder as that of the TV service, and if, as a result of the determination, it is determined that the radio service is within the same transponder, controls the channel select units, the display unit, and the audio output unit to receive the TV service and the radio service at the same time and output video of the TV service and audio of the radio service.

In another aspect, a broadcasting receiver may comprise one or more channel select units for receiving TV and radio services, a first display unit, a second display unit, a plurality of audio output units, an OSD generator, and a controller. The controller controls the second display unit to display information on a received radio service while controlling the audio output units to output audio of the radio service in a state where the first display unit is switched off when receiving and playing the radio service, and if an OSD picture that cannot be displayed on the second display unit is requested by a user, switches on the first display unit and controls the first display unit to display the requested OSD picture.

In still another aspect, a broadcasting receiver may comprise one or more channel select units for receiving TV and radio services, a first display unit, a second display unit, a plurality of audio output units, an OSD generator, and a controller. The controller the controller determines a type of a selected broadcasting service and a type of audio received through the broadcasting service, selectively enables part or all of the plurality of audio output units based on the determination, and controls the audio of the broadcasting service to be output through enabled audio output units.

### BRIEF DESCRIPTION OF THE DRAWINGS

The implementation of this document will be described in detail with reference to the following drawings in which like numerals refer to like elements.

FIG. 1 is a view illustrating an external appearance of a TV and radio broadcasting receiver to which this document is applied;

FIG. 2 is a view illustrating an internal construction of the TV and radio broadcasting receiver to which this document is applied;

FIG. 3 is a flowchart illustrating a video and audio output control method in the TV and radio broadcasting receiver according to an embodiment of this document;

FIG. 4 is a view illustrating an embodiment in which TV video and radio audio are displayed and output independently according to an embodiment of this document;

FIG. 5 is a view illustrating an embodiment in which only a radio list screen and radio audio are output according to an embodiment of this document;

FIG. 6 is a flowchart illustrating a display control method in the TV and radio broadcasting receiver according to another embodiment of this document;

FIG. 7 is a view illustrating a state where display is controlled when TV service is selected through an Electronic Program Guide (EPG) screen according to another embodiment of this document;

FIG. 8 is a view illustrating a state where display is controlled when radio service is selected through an EPG screen according to another embodiment of this document;

FIG. 9 is a view illustrating an external appearance of a TV and radio broadcasting receiver according to still another embodiment of this document;

FIG. 10 is a view illustrating an internal construction of the TV and radio broadcasting receiver according to still another embodiment of this document;

FIG. 11 is a flowchart illustrating an audio output control method in the TV and radio broadcasting receiver according to still another embodiment of this document;

FIG. 12 is a view illustrating a state where an audio output is controlled when radio service is selected according to still another embodiment of this document; and

FIG. 13 is a view illustrating a state where an audio output is controlled when TV service is selected according to still another embodiment of this document.

### DETAILED DESCRIPTION

Hereinafter, implementations of this document will be described in detail with reference to the attached drawings.

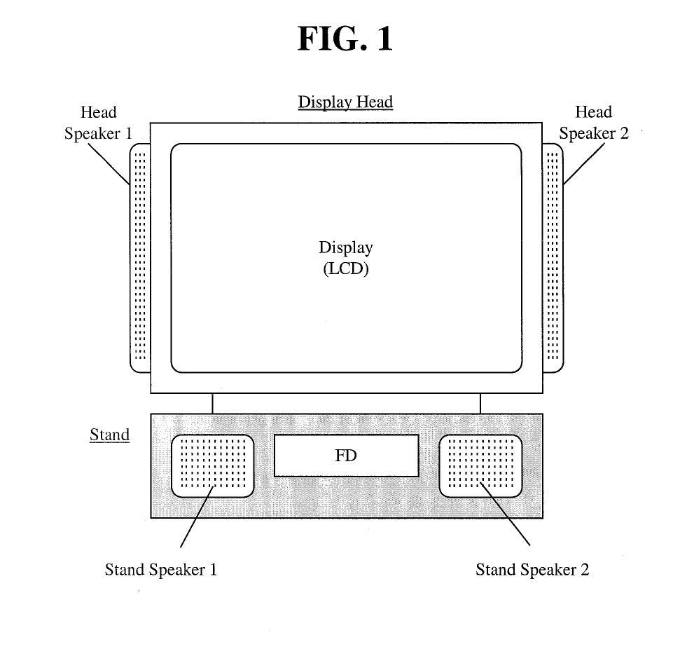

FIG. 1 is a view illustrating an external appearance of a TV and radio broadcasting receiver to which this document is applied. TV according to this document has a structure in which a display head and a stand are coupled. A large-sized flat display (for example, a LCD) and first and second head speakers 1 and 2 are installed in the display head. A small-sized Front Display (FD) panel and first and second stand speakers 1 and 2 are installed in the stand.

In this document, a Tweeter speaker of 3 W output is used as the first and second head speakers. However, a woofer speaker of 5 W output may be used as the first and second head speakers.

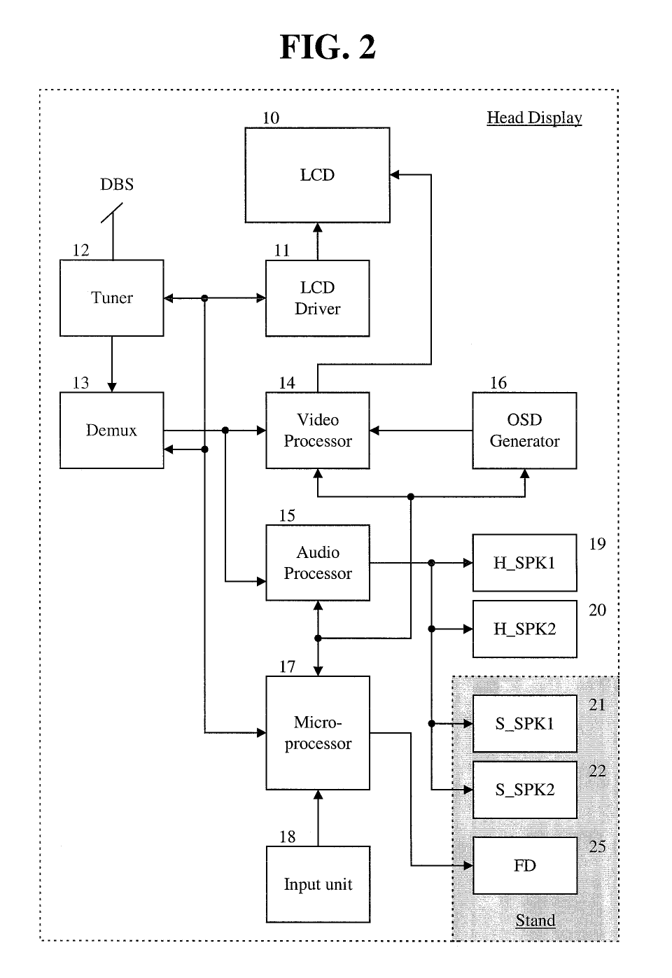

FIG. 2 is a view illustrating an internal construction of the TV and radio broadcasting receiver to which this document is applied.

The display head comprises a LCD 10, a LCD driver 11, a tuner 12, a demux 13, a video processor 14, an audio processor 15, an OSD generator 16, first and second head speakers 17 and 18, a microprocessor 17, an input unit 18, and so on. A stand comprises first and second stand speakers 21 and 22, a FD panel 25, and so on.

If a user selects one broadcasting channel, the microprocessor 17 controls the tuner 12 to select a transponder (TP) comprising a service of a corresponding broadcasting channel and then controls the demux 13 to select and receive a service of the broadcasting channel from several services that are multiplexed in the transponder.

When the received service is TV service, TV video processed by the video processor 14 is displayed on the LCD 10 and TV audio processed by the audio processor 15 is output through the first and second head speakers 19 and 20. At this time, the TV audio may be output through the first and second stand speakers 21 and 22 provided in the stand upon a user's request.

If the user requests display of a radio service list while seeing and hearing selected TV service, the microprocessor 17 controls the OSD generator 16 to generate a radio service list and controls the video processor 14 to display the generated radio service information on the LCD 10.

If one radio service is selected through the radio service list, the microprocessor 17 determines whether the selected radio service is within the same transponder as that of the TV service that is now being received. If, as a result of the determination, it is determined that the selected radio service is within the same transponder, the microprocessor 17 controls the demux 13 to receive the TV service and the radio service at the same time.

The microprocessor 17 controls video of the TV service, which is processed by the video processor 14, to be displayed on the LCD 10 and, at the same time, controls audio of the radio service, which is processed by the audio processor 15, to be output through the speakers 19 and 20, and 21 and 22. Accordingly, a user can listen to radio audio while seeing the TV video. This is described in detail below.

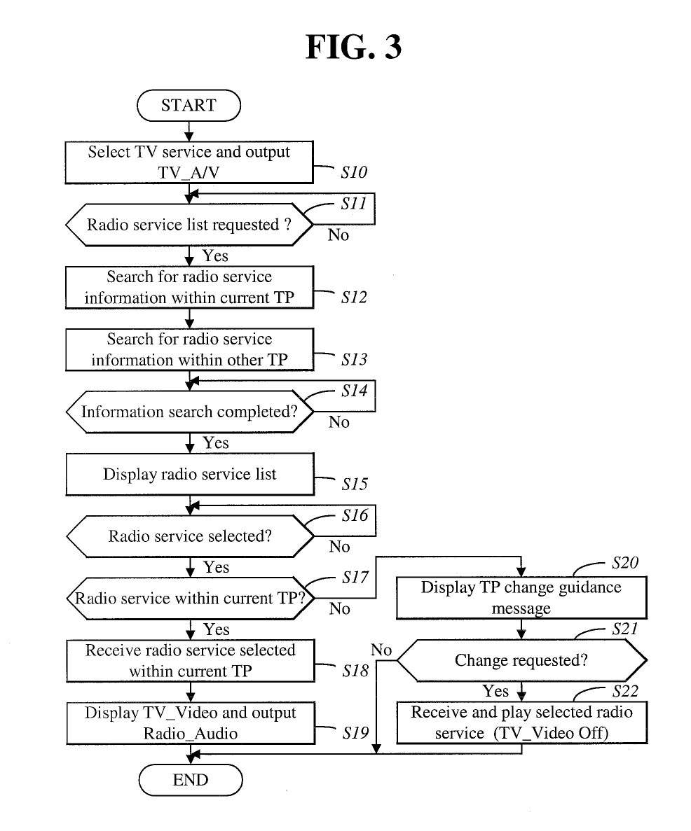

FIG. 3 is a flowchart illustrating a video and audio output control method in the TV and radio broadcasting receiver according to an embodiment of this document.

The microprocessor 17 controls the tuner 12 and the demux 13 to select a transponder and a TV service of a TV broadcasting channel desired by a user and, at the same time, controls video and audio of the TV service to be displayed through the LCD 10 and the first and second head speakers 19 and 20, as described above with reference to FIG. 2 (S10).

If a user requests display of a radio service list while a typical TV service receive operation is performed (S11), the microprocessor 17 searches for service information (SI) provided through digital broadcasting.

For example, the microprocessor 17 can search for information about a radio service which is multiplexed within a transponder now being selected by the tuner 12 (S12) and can search for information about a radio service that is multiplexed within other transponders (S13). If the searching operation for radio services that are multiplexed within the entire transponders is completed (S14), the microprocessor 17 controls the OSD generator 16 to generate an OSD picture of a radio service list and controls the generated OSD picture to be displayed on the LCD 10 (S15).

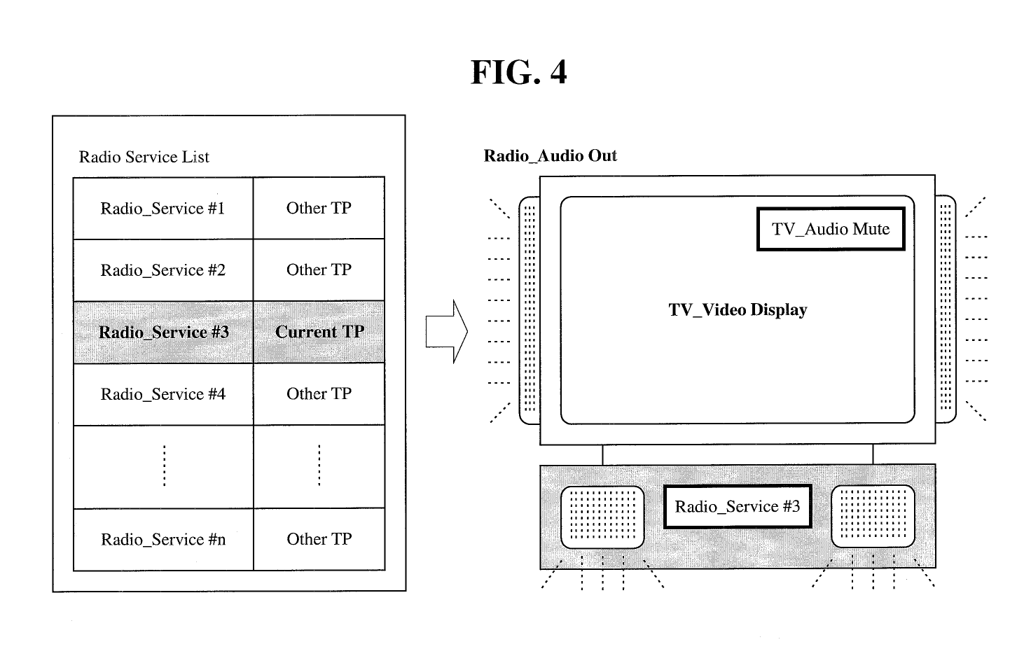

In the radio service list, information about a plurality of radio services Radio_Service #1 to #n are displayed in list form, and whether each radio service belongs to a current transponder (for example, Current TP) or other transponder (for example, Other TP) is dividedly displayed as shown in FIG. 4.

If a user selects one radio service from the displayed radio service list (S16), the microprocessor 17 determines whether the selected radio service belongs to a current transponder (S17).

If, as a result of the determination in step S17, it is determined that the user has selected a radio service (for example, Radio_Service #3) belonging to a current transponder (for example, Current TP) as shown in FIG. 4, the microprocessor 17 controls the demux 13 to additionally select the radio service while maintaining a current TV service and therefore receive the TV service and the radio service at the same time (S18).

The microprocessor 17 then controls the video processor 14 and the audio processor 15 to display video of the TV service on the LCD 10 and to output audio of the radio service through the plurality of the speakers 19 and 20, and 21 and 22 (S19).

In the event that video of the TV service and audio of the radio service are output at the same time as described above, the microprocessor 17 may control the OSD generator 16 to display a message, informing that audio of the TV service is muted (TV_Audio Mute), on part of a screen of the LCD 10.

The microprocessor 17 may control the FD panel 25, disposed at the front of the stand, to display information about a selected radio service (for example, Radio_Service #3).

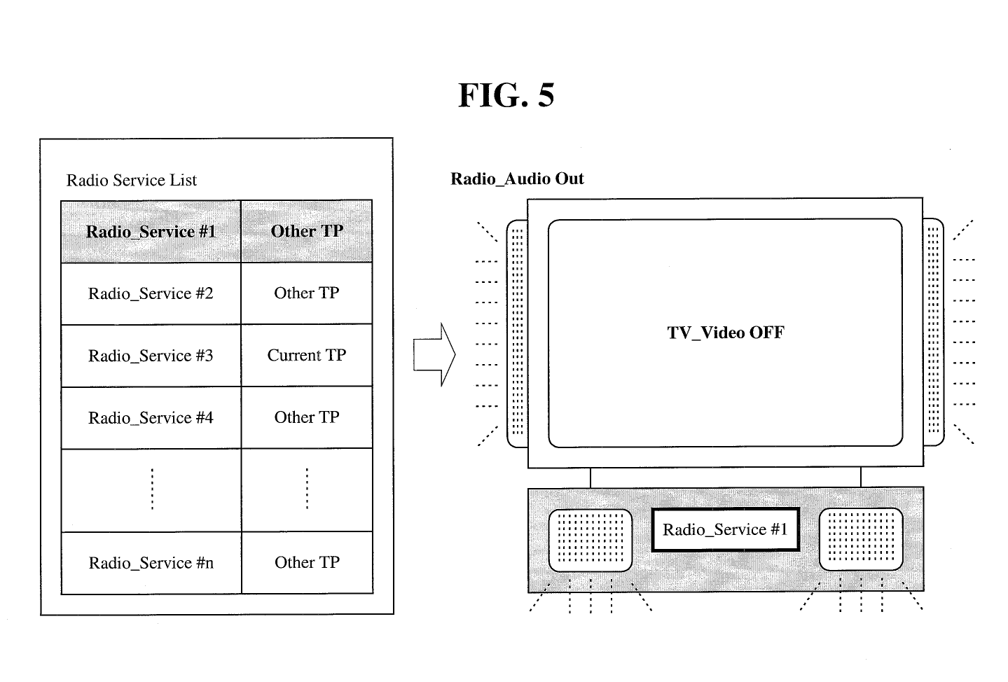

On the other hand, if, as a result of the determination in step S17, it is determined that the user has selected a radio service (for example, Radio_Service #1) belonging to other transponder (for example, Other TP) as shown in FIG. 5, the microprocessor 17 controls the OSD generator 16 to display a guidance message informing that a change to other transponder is necessary (S20).

If the user requests a change in response to the guidance message (S21), the microprocessor 17 controls the tuner 12 to select other transponder comprising the radio service selected by the user and, at the same time, controls the demux 13 to receive a radio service that is multiplexed within the selected transponder, and then controls audio of the received radio service to be output through the plurality of speakers 19 and 20, and 21 and 22 (S22).

At this time, if it is determined that reception of the TV service is not any more valid, the microprocessor 17 may switch off the LCD 10 in order to prevent unnecessary power consumption, etc.

Further, the microprocessor 17 may control the FD panel 25, disposed at the front of the stand, to display information about a radio service that is now selected (for example, Radio_Service #1) and may subsequently control various pieces of audio output information, such as radio volume, to be displayed through the FD panel 25.

For reference, in the event that the radio service and the TV service are received at the same time or only the radio service is received, audio of a high volume and middle/low volumes may be output through all the speakers disposed at the display head and the stand, or some of the speakers may be selectively used upon a user's user.

Meanwhile, if the LCD keeps switched off when a user selects and listens to a radio service as in the previous embodiment, an EPG picture, etc. cannot be displayed on a large screen of the LCD. Consequently, a problem may arise because a broadcasting program desired by a user cannot be searched or selected efficiently.

Therefore, in another embodiment of this document, in the event that there is a request for information about broadcasting programs, such as EPG display request, from a user when a radio service is received and played through the TV and radio broadcasting receiver, the LCD of a main screen (for example, a large screen) that keeps switched off may be automatically switched on and a requested EPG picture may be generated and displayed on the LCD. This embodiment is described below.

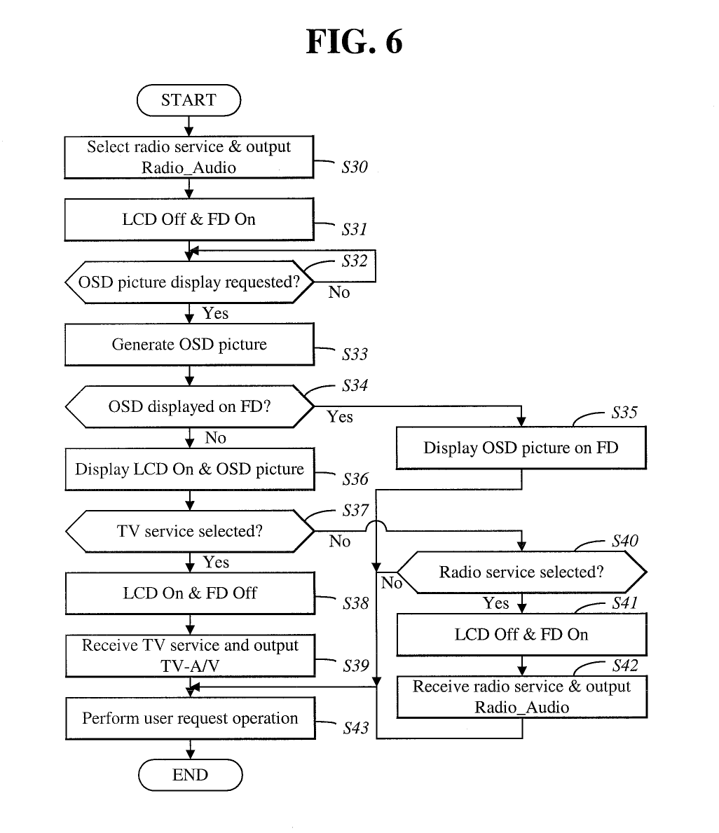

FIG. 6 is a flowchart illustrating a display control method in the TV and radio broadcasting receiver according to another embodiment of this document.

The microprocessor 17 controls the tuner 12 and the demux 13 to select a transponder and a radio service of a radio broadcasting channel desired by a user and, at the same time, controls the audio processor 15 to output audio of the radio service through the plurality of the speakers, as described above with reference to FIG. 2 (S30).

If the operation of receiving a radio service is performed, the microprocessor 17 controls the LCD driver 11 to automatically switch off the LCD 10 and, at the same time, controls the FD panel 25 of a small size, which is equipped in the stand, to display radio service information, an audio output level and so on (S31).

If a user requests information about a broadcasting program, such as an EPG display request, through the input unit 20 in order to select another broadcasting program (S32), the microprocessor 17 controls the OSD generator 16 to generate an OSD picture in response to the user's request (S33). If it is determined that the generated OSD picture can be displayed on the small-sized FD panel 25 (S34), the microprocessor 17 controls the FD panel 25 to display the OSD picture (S35).

However, if, as a result of the determination in step S34, it is determined that the generated OSD picture is an OSD picture, such as an EPG List, which cannot be displayed on the small-sized FD panel 25, the microprocessor 17 controls the LCD 10 to be automatically switched on and then to display the EPG picture (S36).

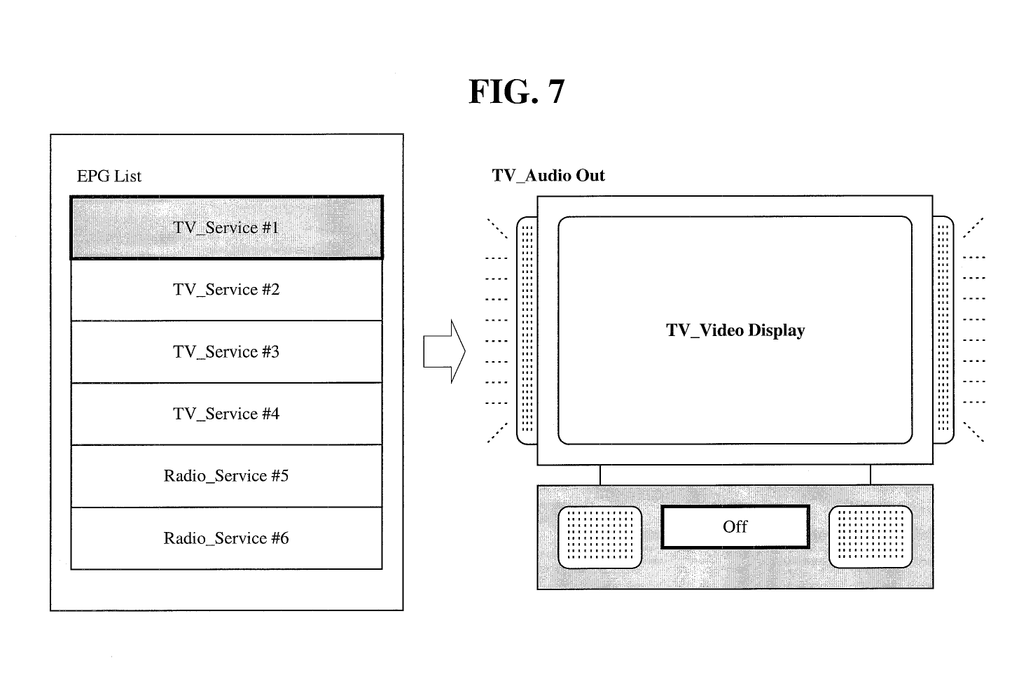

The microprocessor 17 then determines whether the user selects one service from the EPG picture displayed on the LCD 10 (S37). If, as a result of the determination in step S37, it is determined that the user has selected TV service (for example, TV_Service #1) from the EPG picture displayed on the LCD 10 as shown in FIG. 7, the microprocessor 17 switches off the FD panel 25 while maintaining the display on-state of the LCD 10 (S38).

Thereafter, the microprocessor 17 controls the tuner 12 and the demux 13 to receive the TV service, controls the video processor 14 to display video of the TV service on the LCD 10, and controls the audio processor 15 to output audio of the TV service through the first and second head speakers 19 and 20 (S39).

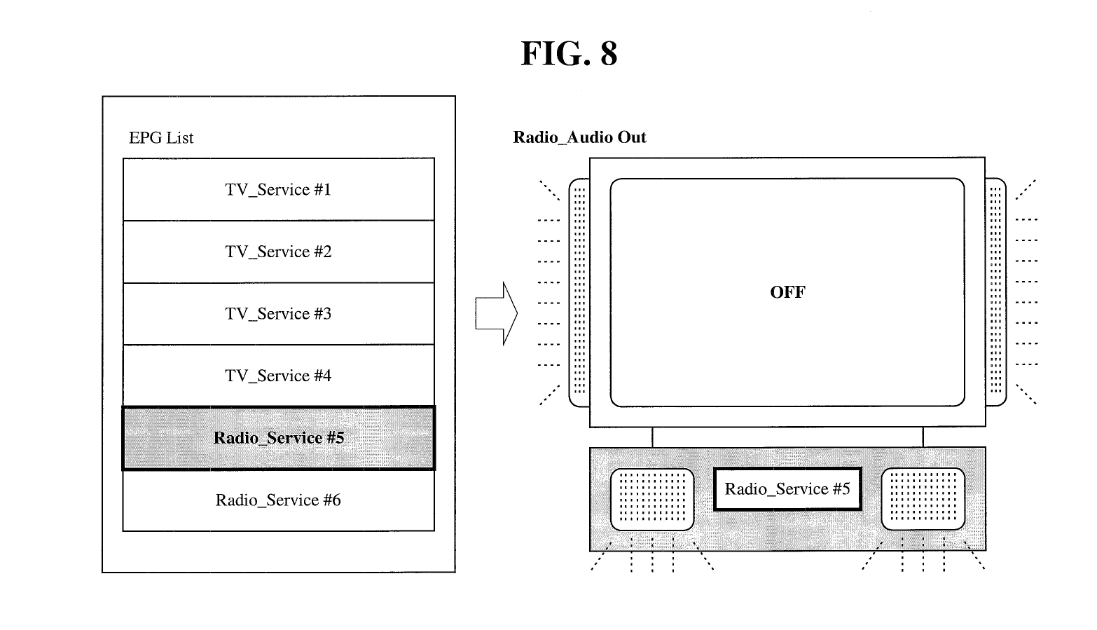

On the other hand, if, as a result of the determination in step S37, it is determined that the user has selected a radio service (for example, Radio_Service #5) from the EPG picture displayed on the LCD 10 (S40) as shown in FIG. 8, the microprocessor 17 controls the LCD 10 to be switched off while maintaining the on state of the FD panel 25 (S41).

The microprocessor 17 then controls the tuner 12 and the demux 13 to receive the radio service and controls the audio processor 15 to output audio of the radio service through the speakers 19 and 20, and 21 and 22 (S42). Radio service information, an audio output level, and so on may be displayed through the FD panel 25.

For reference, in the event that the radio service is received, all or some of the speakers installed in the display head and the stand may be used upon a user's request.

Further, the LCD and the FD panel may be replaced with other types of displays.

Meanwhile, as mentioned earlier, TV services and radio services may be multiplexed within the transponder. In the event that digital TV receives a TV service comprising multi-channel audio such as 5.1 CH, several (for example, six) speakers corresponding to 5.1 CH are necessary. Accordingly, a three-dimensional sound effect can be produced only when an additional device, such as a home theater system, is used.

In the event that several (for example, six) speakers corresponding to 5.1 CH are equipped in digital TV, not only unnecessary power consumption, but also noise may be generated when all the plurality of speakers are enabled with stereo or mono audio being received.

In order to solve the problems, in still another embodiment of this document, the plurality of speakers equipped in the broadcasting receiver may be used selectively according to an audio type of a received broadcasting service.

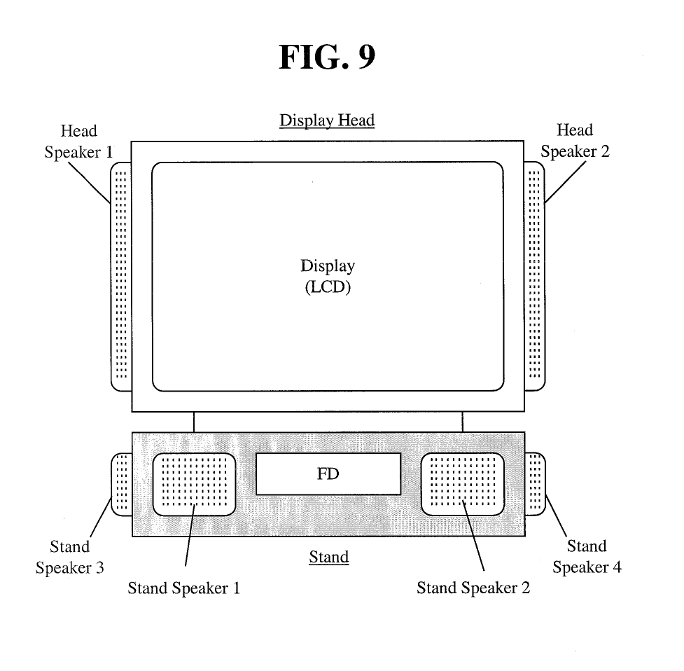

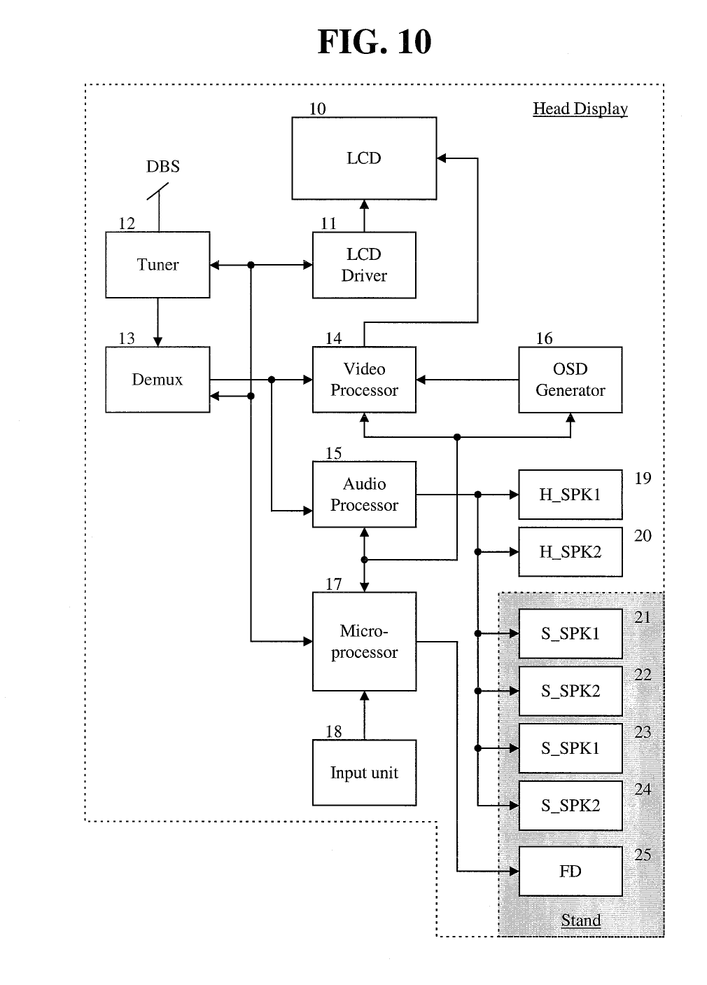

FIGS. 9 and 10 are views illustrating an external appearance and internal construction of a TV and radio broadcasting receiver according to still another embodiment of this document. The external appearance and internal construction of the TV and radio broadcasting receiver according to this embodiment are identical to those of the broadcasting receiver shown in FIGS. 1 and 2 except that first to fourth stand speakers 1 to 4 and 21 to 24 are installed in a stand. Each of the first to fourth stand speakers of the stand may use a speaker of high volume and middle/low volumes having a woofer function of 5 W output.

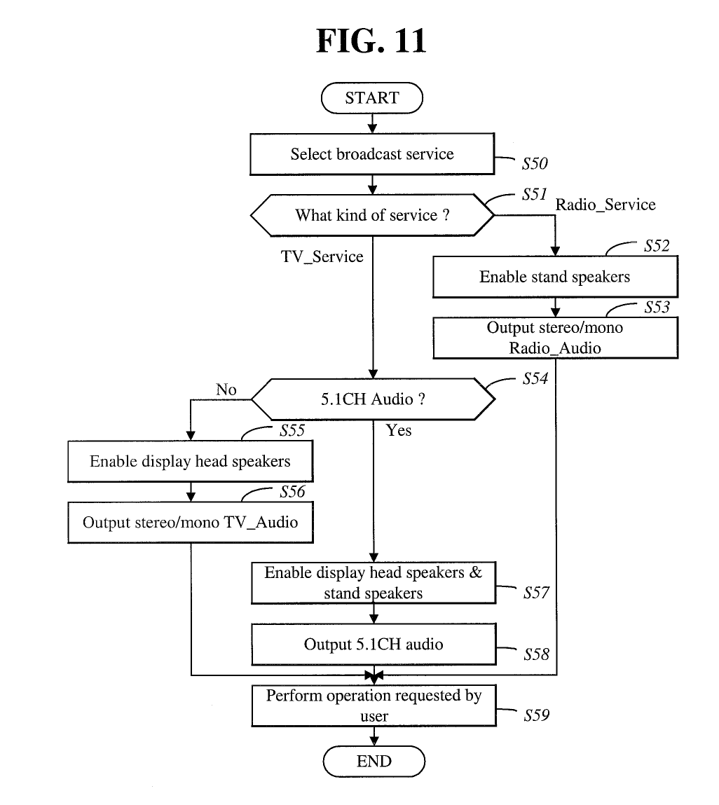

FIG. 11 is a flowchart illustrating an audio output control method in the TV and radio broadcasting receiver according to still another embodiment of this document.

The microprocessor 17 controls the tuner 12 and the demux 13 to receive a TV broadcasting service or a radio broadcasting service from a transponder of a broadcasting channel selected by a user (S50) and then determines the type of a received broadcasting service (S51) If, as a result of the determination in step S51, it is determined that the received broadcasting service is a radio broadcasting service that provides stereo or mono audio, the microprocessor 17 enables the first to fourth speakers 21 to 24 installed in the stand (S52).

The microprocessor 17 then controls the audio processor 15 to output stereo or mono audio, which is received through the radio broadcasting service, through the enabled first to fourth speakers 21 to 24 of the stand (S53).

If, as a result of the determination in step S51, it is determined that the received broadcasting service is a TV broadcasting service, the microprocessor 17 determines whether the type of audio comprised in a corresponding TV broadcasting service is 5.1 CH (S54). If, as a result of the determination in step S54, it is determined that the type of audio is general stereo or mono audio, the microprocessor 17 enables only the first and second speakers 19 and 20 installed in the display head (S55) and then controls the audio processor 15 to output the stereo or mono audio, which is received through the TV broadcasting service, through the enabled first and second speakers 19 and 20 of the display head (S56).

If, as a result of the determination in step S54, it is determined that the type of audio is audio of 5.1 CH, the microprocessor 17 enables all the first and second speakers 19 and 20 installed in the display head and the first to fourth speakers 21 to 24 installed in the stand (S57), and then controls the audio processor 15 to output the 5.1 CH audio, which is received through the TV broadcasting service, through the first and second speakers 19 and 20 of the display head and the first to fourth speakers 21 to 24 of the stand, all of which are enabled (S58).

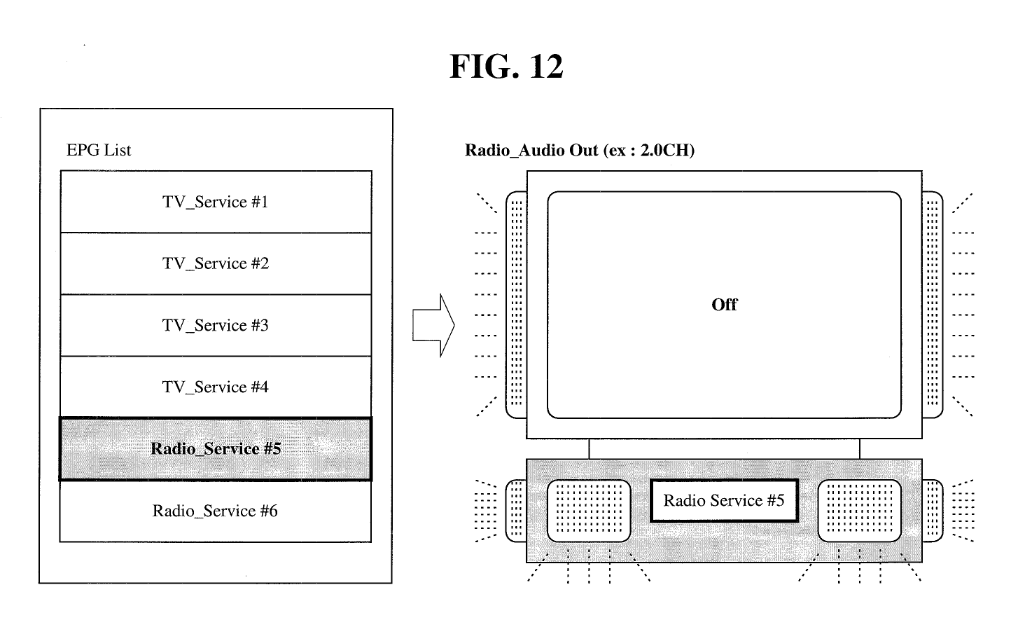

For example, if stereo audio of 2.0 CH is received through a radio broadcasting service selected from an EPG screen by a user as shown in FIG. 12, the first to fourth speakers of the stand are enabled, so that audio of 2 CH stereo can be output efficiently without unnecessary power consumption and noise.

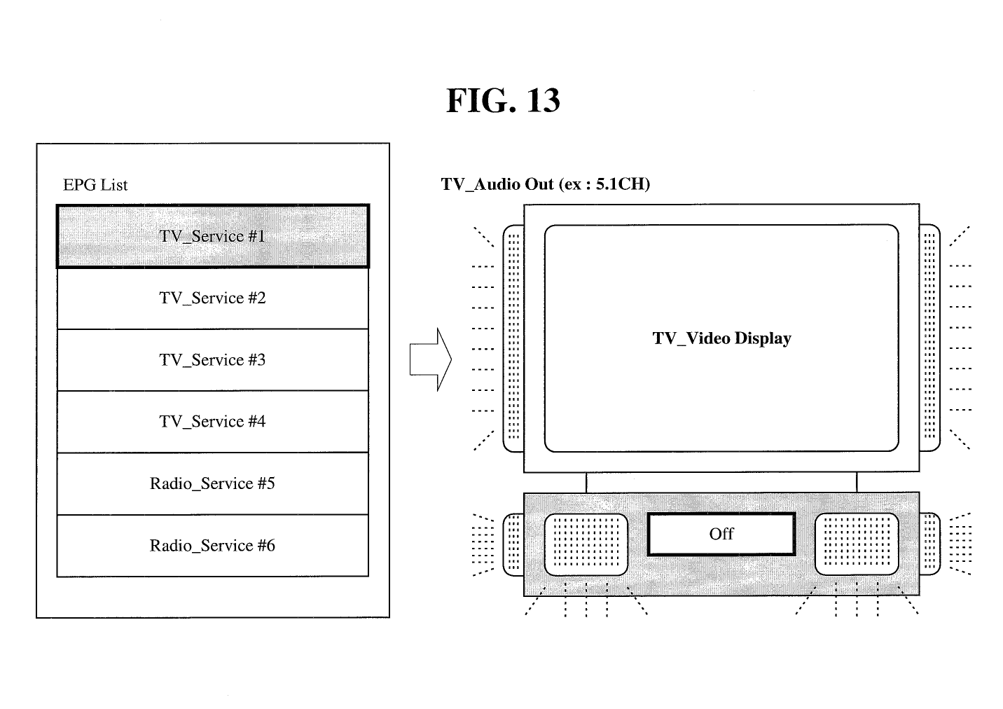

Further, if audio of 5.1 CH is received through a radio broadcasting service selected by a user from an EPG screen as shown in FIG. 13, the first to fourth speakers of the stand and the first and second speakers of the display head are all enabled, so that a three-dimensional sound effect can be generated.

The microprocessor 17 may generate an audio output state desired by a user by manually disabling the speakers that are automatically enabled or manually enabling the speakers that are not enabled upon a user's request or the like.

Further, when audio of 5.1 CH is provided though a radio broadcasting service, all the six speakers may be enabled in order to generate a three-dimensional sound effect.

Accordingly, a user can listen to audio of a radio broadcasting while seeing video of TV broadcasting, and unnecessary power consumption, instrumental vibration, noise, and so on can be reduced. Consequently, durability of a device and user convenience can be improved.

While this document has been described in connection with what is presently considered to be practical exemplary embodiments, it is to be understood that this document is not limited to the disclosed embodiments, but, on the contrary, is intended to cover various modifications and equivalent arrangements included within the spirit and scope of the appended claims.

What is claimed is:

1. A broadcasting receiver comprising one or more channel select units for receiving TV and radio services, a display unit, a plurality of audio output units, and a controller,
wherein if a radio service is selected while a TV service is played, the controller determines whether the radio service is within the same transponder as that of the TV service, and if, as a result of the determination, it is determined that the radio service is within the same transponder, controls the channel select units, the display unit, and the audio output unit to receive the TV service and the radio service at the same time and output video of the TV service and audio of the radio service.

2. The broadcasting receiver of claim 1, further comprising a second display unit for displaying information about the received radio service,
wherein the channel select units, the display unit, part of the plurality of audio output units, and the controller are equipped in a display head, and
the remaining of the plurality of audio output units and the second display unit are equipped in a stand connected to the display head through a cable.

3. The broadcasting receiver of claim 1, further comprising an OSD generator for generating a picture comprising information related to TV and radio services,
wherein if there is a request for a radio service list from a user while the TV service is played, the controller searches for radio services within respective transponders, and controls the OSD generator to generate the radio service list based on the searched result with the radio services within the same transponder as that of the TV service that is being played being discriminated from radio services within other transponders.

4. The broadcasting receiver of claim 3, wherein the controller controls the OSD generator and the display unit to display a message, informing that audio of the TV service is not output, when the video of the TV service and the audio of the radio service are output at the same time.

5. The broadcasting receiver of claim 3, wherein if a radio service within a transponder different from that of the TV service is selected, the controller controls the OSD generator, the channel select units, and the audio output units to display a message informing a change to other transponder, change to a transponder that provides the selected radio service, and receive and output the selected radio service.

6. The broadcasting receiver of claim 5, wherein the controller switches off the display unit and displays information about the received radio service on a FD panel provided separately from the display unit.

7. A broadcasting receiver comprising one or more channel select units for receiving TV and radio services, a first display unit, a second display unit, a plurality of audio output units, an OSD generator, and a controller,
wherein the controller controls the second display unit to display information on a received radio service while controlling the audio output units to output audio of the radio service in a state where the first display unit is switched off when receiving and playing the radio service, and if an OSD picture that cannot be displayed on the second display unit is requested by a user, switches on the first display unit and controls the first display unit to display the requested OSD picture.

8. The broadcasting receiver of claim 7, wherein the channel select units, the first display unit, part of the plurality of audio output units, the OSD generator, and the controller are equipped in a display head, and the remaining of the plurality of audio output units and the second display unit are equipped in a stand connected to the display head through a cable.

9. The broadcasting receiver of claim 7, wherein if a TV service is selected in a state where the OSD picture is displayed, the controller controls the channel select units, the first display unit, and the audio output units to maintain the on state of the first display unit and tune and play the selected TV service.

10. The broadcasting receiver of claim 9, wherein the controller switches off the second display unit.

11. The broadcasting receiver of claim 7, wherein if a radio service is selected in a state where the OSD picture is displayed, the controller controls the channel select units, the first display unit, and the audio output units to switch off the first display unit and tune and play the selected radio service.

12. A broadcasting receiver comprising one or more channel select units for receiving TV and radio services, a first display unit, a second display unit, a plurality of audio output units, and a controller,
wherein the controller determines a type of a selected broadcasting service and a type of audio received through the broadcasting service, selectively enables part or all of the plurality of audio output units based on the determination, and controls the audio of the broadcasting service to be output through enabled audio output units.

13. The broadcasting receiver of claim 12, wherein the channel select units, the first display unit, part of the plurality of audio output units, and the controller are equipped in a display head, and the remaining of the plurality of audio output units and the second display unit are equipped in a stand connected to the display head through a cable.

14. The broadcasting receiver of claim 13, wherein the controller enables all the audio output units equipped in the display head and the stand when the broadcasting service is a TV service and the type of audio is 5.1 CH.

15. The broadcasting receiver of claim 13, wherein the controller enables the audio output units equipped in the display head when the broadcasting service is a TV service and the type of audio is stereo or mono.

16. The broadcasting receiver of claim 13, wherein the controller enables the audio output units equipped in the stand when the broadcasting service is a radio service.

17. The broadcasting receiver of claim 13, wherein the controller enables or disables part of the audio output units upon a user's request.
